(19) United States
(12) Patent Application Publication
(10) Pub. No.: US 2024/0402972 A1
(43) Pub. Date: Dec. 5, 2024

(54) Enabling Multitasking On A Primary User Device By Using A Secondary Device To Handle Functional Aspects Of An Application Being Executed By The Primary User Device

(71) Applicant: Apple Inc., Cupertino, CA (US)

(72) Inventors: Jad Osseiran, San Francisco, CA (US); Bradley D. Ford, San Jose, CA (US); Yu Xing, San Jose, CA (US)

(73) Assignee: Apple Inc., Cupertino, CA (US)

(21) Appl. No.: 18/446,355

(22) Filed: Aug. 8, 2023

Related U.S. Application Data
(60) Provisional application No. 63/506,113, filed on Jun. 4, 2023.

(51) Int. Cl. G06F 3/14; G06F 9/4401; H04L 65/1089; H04L 65/613; H04L 65/80

(52) U.S. Cl. CPC G06F 3/1423; G06F 9/4418; H04L 65/1089; H04L 65/613; H04L 65/80; G06F 3/0484

(57) ABSTRACT

A first device is used to execute a first application for conducting a video call. The first application displays a video stream of the video call on a display screen of the first device using voice data and video data captured by the first device. When a first trigger condition is detected, either by the operating system of the first device or by the operating system of the first application, the first device transfers the display of the video stream of the video call to a second device. Although the video stream is being displayed on the second device, the first application continues to use the first device to capture the voice data and the video data for the video call. At the same time, the first device is displaying the video stream on the second device, the first device is also displaying application data corresponding to a second application.

### INCORPORATION BY REFERENCE; DISCLAIMER

The following application is hereby incorporated by reference: application No. 63/506,113 filed on Jun. 4, 2023. The Applicant hereby rescinds any disclaimer of claim scope in the parent application(s) or the prosecution history thereof and advises the USPTO that the claims in this application may be broader than any claim in the parent application(s).

### TECHNICAL FIELD

The disclosure generally relates to multitasking on a primary device that is concurrently being used for capturing audio/visual information for the video call.

### BACKGROUND

Smart phones and other similar devices may be used to make video calls. To increase the size of a picture on the video call and/or for improved audio, a user may mirror the video call, being displayed on a smart phone, on a nearby television.

### OVERVIEW

In some embodiments, a first device, e.g., tablet, is initially used to execute a first application for conducting a video call, using voice data and video data captured by the physical hardware of the first device. The physical hardware of the first device may include, for example, a microphone and a camera. The first application initially displays a video stream corresponding to the video call on a display screen of the first device. While displaying the video stream corresponding to the video call on the display screen of the first device, the first application or an operating system executing on the first device detects a trigger condition. The trigger condition may include an explicit command received from a user to transfer displaying of the video stream from the display screen of the first device to a display screen of the second device. Alternatively, or additionally, the trigger condition may be determining that the display screen of the first device, that was previously being used for displaying the video stream corresponding to the video call, is now being used to display information corresponding to a second application. When the trigger condition is detected, the first device transfers the display function of the video stream for the video call from the display screen of the first device to a display screen of a second device while (a) continuing to use the physical hardware of the first device to capture audio/video data for the video call and (b) using the display screen of the first device for displaying information corresponding to a second application.

Particular embodiments provide at least the following advantages. The system enables multitasking on the first device by (a) using the physical hardware of the first device for capturing audio/visual data for the video call maintained by a first application, (b) causing display of a video stream corresponding to the video call on a video screen of a second device, and (c) causing display of information corresponding to a second application on a video screen of the first device. The enabling of multitasking on a device in such a manner is a feature not present in conventional systems.

Details of one or more implementations are set forth in the accompanying drawings and the description below. Other features, aspects, and potential advantages will be apparent from the description and drawings, and from the claims.

### DESCRIPTION OF DRAWINGS

FIG. 1A is a block diagram of an example system for using a first device to conduct a video call displayed on a second device while maintaining the functionality of the first device.

FIG. 1B is a block diagram of the first device of the example system shown in FIG. 1A.

FIG. 2 is flow diagram of an example process for maintaining the functionality of a first device while using the first device to conduct a video call displayed on a second device.

FIGS. 3A-3C are illustrations of the displays of first and second devices during a video call in accordance with the disclosure.

FIG. 4 is a block diagram of an example computing device that can implement the features and processes of FIGS. 1-3C.

Like reference symbols in the various drawings indicate like elements.

### DETAILED DESCRIPTION

### Maintaining Functionality During a Video Call

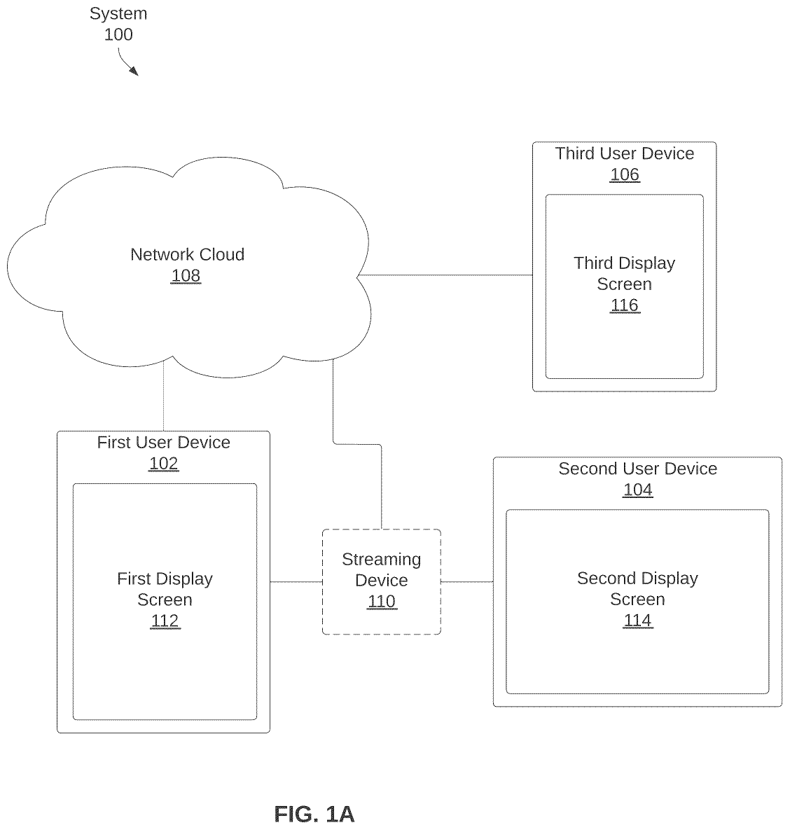

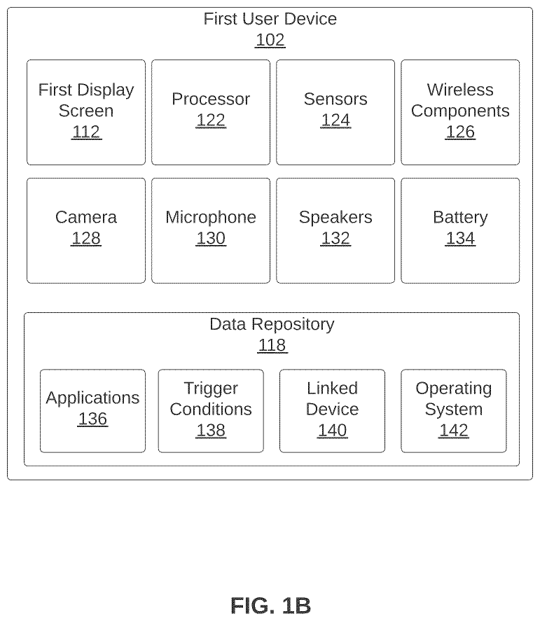

FIG. 1A is a block diagram of an example system 100 for enabling multi-tasking on a user device including executing a first application for a video call and an additional, second application. The system 100 includes a first user device 102, a second user device 104 connected to the first user device 102, and a third user device 106 connected to the first user device 102 by a network cloud 108. As will be described in further detail below, in some embodiments the first user device 102 is connected to the second user device 104 by a streaming device 110.

In one or more embodiments the first user device 102 is a tablet or smart phone. Tablets are designed for general use by individuals and offer a wide range of features, such as web browsing, multimedia consumption, productivity apps, gaming, social media access, and video calls. Examples of tablets include, Apple iPad, Samsung Galaxy Tab, and Amazon Fire. The first user device 102 includes a first display screen 112 for displaying video. As will be described in further detail below, the first user device 102 also includes at least one camera and at least one microphone for enabling video calling.

In some embodiments the second user device 104 is a television, monitor or other secondary display device. The second user device 104 may even be a tablet. The second user device 104 includes a second display screen 114. In one or more embodiments, the second user device 104 is a smart TV. A smart TV is a television equipped with built-in internet connectivity and integrated software platforms, enabling access to a variety of online content and services. Smart TVs combine traditional television capabilities with internet-based functionalities. Smart TVs may have different operating systems or software platforms, such as webOS (LG), Tizen (Samsung), Android TV (Google), or Roku OS (Roku). The platforms provide the interface and ecosystem for accessing apps, content, and settings on the Smart TV.

In some embodiments, when the second user device 104 itself is unable to receive and display a video stream directly from the first user device 102, the streaming device 110 is utilized to transfer the video stream from the first user device 102 to the second user device 104. Streaming devices are devices that allow users to stream digital content from various online sources and services onto a television screen or other display device. Streaming devices typically connect to the internet and provide access to a wide range of streaming services, apps, and content libraries. Examples of streaming devices include Apple TV, Roku, Amazon Fire TV, and Google Chromecast.

In one or more embodiments, the network cloud 108 may be a local area network (LAN), a wide area network (WAN), a cellular network, a Wi-Fi network, a virtual private network (VPN) or a satellite network. A LAN is a network that covers a limited area, such as a home, office, or campus. When video calling within a LAN, devices are typically connected through wired or wireless connections, allowing for fast and reliable communication. A WAN spans larger distances and can connect devices across different locations. Internet-based video calling services like Skype, Zoom, or FaceTime utilize the WAN infrastructure to facilitate video calls between users located in different regions. The network cloud 108 may include cellular networks, such as 3G, 4G, or 5G. Cellular networks allow for video communication on mobile devices even when not connected to Wi-Fi. Wi-Fi networks provide wireless connectivity within a specific area, such as a home or office. Wi-Fi allows devices to connect to the internet and enables video calls over internet-based services. A VPN allows for creation of secure connections over a public network, such as the internet. VPNs are used to establish secure connections between remote locations or to enable remote workers to access their corporate networks. Video calls can be conducted through VPN connections for enhanced privacy and security. In remote areas or situations where traditional network infrastructure is unavailable, satellite networks can provide connectivity for video calls. Satellite-based communication systems transmit data between satellite stations and user terminals, enabling communication over long distances.

In one or more embodiments the third user device 106 is used by another participant(s) on the video call. The third user device 106 includes a third display screen 116. In some embodiments, the third user device 106 includes a smart phone, a tablet, a laptop or desktop, or smart TV enabled with built-in cameras and support video calling apps or services. Although only the third user device 106 is shown, it is envisioned that the video call may be conducted with more than one other participant.

FIG. 1B illustrates a block diagram of the components of the first user device 102. The first user device 102 includes the first display screen 112, one or more processors 122, one or more sensors 124, one or more wireless components 126, at least one camera 128, at least one microphone 130, one or more speakers 132, a battery 134, and a data repository 118. In some embodiments, the data repository 118 stores applications 136, trigger conditions 138, linked devices 140, and operating system 142.

In embodiments, the first display screen 112 is a touch screen. In this manner, user engagement with the first display screen 112, with, for example, a finger or a stylus, allows for user interaction with the operating system 142 and applications 136 on the first user device 102.

In some embodiments, the processor 122 on the first user device 102 executes instructions from the operating system 142 and applications 136. These instructions are in the form of machine code and encompass operations like arithmetic calculations, data manipulation, and control flow. The processor 122 performs data processing operations, handles tasks like adding numbers, sorting data, performing complex algorithms, and executing software instructions. The processor 122 manages execution of instructions by coordinating data flow and control signals within the CPU. The processor 122 communicates with the memory system of the first user device 102 to retrieve and store data. The processor 122 manages data transfers between different levels of memory hierarchy, such as cache and RAM. In some embodiments, the processor 122 incorporates power management features to optimize energy consumption. The processors 122 may dynamically adjust clock speed, voltage, and power usage based on workload demands, helping to extend battery life of the first user device 102.

The first user device 102 may include sensors 124. Various sensors include accelerometers, gyroscopes, ambient light sensors, and proximity sensors. An accelerometer detects an orientation of the device and measures acceleration forces, allowing the first user device 102 to respond to changes in position and motion. The accelerometer enables features like auto-rotation of the screen, tilt-based gaming, and motion-based gestures. A gyroscope works in conjunction with the accelerometer to measure angular velocity and rotation. The gyroscope provides more precise information about the orientation of the first user device 102, enabling more accurate motion tracking and augmented reality applications. The ambient light sensor adjusts the brightness of the first display screen 112 based on the surrounding lighting conditions. The ambient light sensor ensures optimal visibility by automatically adapting the screen brightness to match the ambient environment. A proximity sensor detects the presence of nearby objects or the proximity of the user's face during a video call. A proximity sensor is commonly used to turn off the touchscreen when the device is held to the car to prevent accidental touch inputs and save power.

The sensors 124 of the first user device 102 may further include magnetometers, GPS, barometers, fingerprint sensors, and hall effector sensors. A magnetometer functions as a digital compass, measuring the Earth's magnetic field. The magnetometer allows the tablet to determine its orientation in relation to magnetic north and is useful for navigation, map applications, and augmented reality. Many devices include a GPS sensor to determine a precise geographical location of the device. GPS enables location-based services, such as mapping, navigation, and geolocation applications. A barometer sensor measures atmospheric pressure and provides information about altitude changes, weather forecasting, and assists in determining elevation for location-based applications. A fingerprint or sensor permits biometric authentication, allowing users to securely unlock the device or authorize secure transactions using their fingerprint. A Hall effect sensor detects the presence and strength of a magnetic field and may be used for various purposes, such as detecting opening and closing of a device cover or activating magnetic attachments like keyboard cases.

In some embodiments, the first user device 102 includes several wireless components 126 that enable connectivity and communication with other devices and networks. The wireless components 126 enable communication of the first user device 102 over Wi-Fi, Bluetooth, and cellular connectivity. Wi-Fi allows the device to connect to wireless local area networks (WLANs) and access the internet. Embodiments may support various Wi-Fi standards, such as 802.11a/b/g/n/ac/ax, providing different levels of speed, range, and compatibility. Bluetooth enables short-range wireless communication between the tablet and other Bluetooth-enabled devices. Wi-Fi allows for connections with accessories like wireless headphones, keyboards, speakers, and other peripherals. Tablets typically support various Bluetooth versions, including the latest Bluetooth 5.0 or higher. Some embodiments include built-in cellular connectivity, allowing for connection to cellular networks like 4G LTE or 5G. With cellular connectivity, the first user device 102 may be used to access the internet and make calls or send messages using a mobile data plan, similar to a smartphone.

In one or more embodiments, the first user device 102 includes wireless components 126 for utilizing near field communication (NFC), GPS, and infrared (IR) blaster. NFC is a wireless technology that enables close-range communication between devices by bringing them into proximity. Devices equipped with NFC can support functions like contactless payments, file transfers, and pairing with other NFC-enabled devices. In embodiments, the first user device 102 includes a GPS receiver, which enables location-based services and navigation. The GPS component uses satellite signals to determine precise geographical coordinates of the first user device 102 and provide accurate positioning information. The infrared blaster allows the first user device 102 to be used as a remote control for various infrared devices like TVs, DVD players, and home entertainment systems. The infrared blaster enables control of compatible devices directly from the first user device 102. Wi-Fi Direct enables the first user device 102 to establish a direct wireless connection with other Wi-Fi Direct-enabled devices without a traditional Wi-Fi network. Examples of services that implement Wi-Fi Direct include Apple AirDrop, Android Nearby Share, Samsung Smart View, Windows 10 Nearby Sharing, Intel WiDi.

In embodiments, the first user device 102 includes at least one camera 128. In some embodiments, the first user device 102 includes a front facing camera. The front facing camera, also known as the selfie camera, is positioned on a front of the first user device 102, adjacent the first display screen 112. The front facing camera is optimized for video calls, taking selfies, and capturing content while facing the user. The resolution of the front facing camera may be lower than the rear camera. In embodiments, the first user device 102 includes a rear facing camera positioned on the back of the first user device 102. The rear facing camera is primarily used for capturing photos and videos. The rear facing camera may have higher resolution and quality compared to the front facing camera.

In some embodiments, the first user device 102 includes at least one microphone 130. Microphones 130 enable performance of a variety of functions including. voice and video calls, voice recordings, voice commands and virtual assistants, multimedia capture, and speech to text. The first user device 102 may include a microphone accompanying either or both of the front facing camera and the rear facing camera. The camera being utilized will determine which of the microphones is activated.

In some embodiments, the first user device 102 includes speakers 132 for providing audio output. The speakers 132 permit functions such as media playback, voice and video calls, alarms, alerts and notifications, and multimedia presentations.

In embodiments the battery 134 of the first user device 102 includes a rechargeable battery for powering the first user device 102. The battery life of the battery 134 depends on factors such as screen brightness, usage patterns, running apps, and other power-consuming activities.

In some embodiments, the first user device 102 includes a plurality of applications 136. The applications 136 may include productivity apps, communication apps, entertainment apps, creative and multimedia apps, educational apps, and health and fitness apps. In embodiments, the applications 136 are initiated by selecting an icon displayed on a home screen of the operating system 142 of the first user device 102 corresponding to the desired application. In some embodiments, the user may select the icon corresponding to the desired application by tapping the icon with a finger or a stylus.

User actions for reengaging a minimized open application and minimizing and/or closing an open application vary depending on the operating system of the first user device 102. For example, on iOS, a user swipes up from the bottom of the screen (starting from the bottom edge) and pause in the middle of the screen to reveal an app switcher. In the app switcher, preview cards for the open applications are viewable. Swiping left or right allows the user to sort through the open applications to locate the application for reengaging or minimizing the open application. Tapping on the preview card of the target application maximizes or reengages the open application. Swiping up on, or flicking the preview card for the open application, minimizes the application and returns the user to the home screen or to the previously used application. On Android devices, one way a user reengages a minimized open application or minimizes an open application is by using navigation buttons. By tapping on the square or recent apps button (usually located at the bottom of the screen), the user accesses app cards in a recent apps view. Swiping left or right allows the user to sort through the app cards to locate the app card of the application to be reengaged or minimize. Tapping on the app card maximizes or reengages the open application. Tapping outside of the app cards returns the user to the home screen or to the previously used application. On Windows devices, an open application may be minimized by clicking on a minimize button which is usually located in the top-right corner of the application window. Minimizing the open application will shrink the application window and return the user to the desktop/home screen or the previously used application.

In one or more embodiments the data repository 118 includes trigger conditions 138 that initiate a transfer of a video stream being displayed on the first display screen 112 of the first user device 102 to being displayed on the second display screen 114 (FIG. 1A) of the second user device 104. The data repository 118 also includes trigger conditions 138 that initiate transfer of a video stream back to the first user device 102 from the second user device 104.

In some embodiments, the trigger conditions 138 for initiating the transfer of the video stream from the first user device 102 to the second user device 104 include detecting user engagement with a user interface element for initiating the transfer of the video stream from the first user device 102 to the second user device 104. In some embodiments, the user interface element for initiating the transfer is displayed on the first screen display 112 of the first user device 102 and may be displayed concurrently with the video stream. In some embodiments, the user interface element for initiating the transfer to the second user device 104 is displayed with a swiping motion.

In some embodiments, the trigger conditions 138 for initiating the transfer from the first user device 102 to the second user device 104 include detecting that the second user device is available. The second user device 104 may become available when the second user device 104 is plugged in or powered on. The second user device 104 may become available when a method of communicating between first user device 102 and the second user devices 102 is activated or enabled. For example, enabling Bluetooth on the first user device 102 and the second user device 104 allows the second user device 104 to be discovered by the first user device 104. Similarly, coming into range of the second user device 104 or directly connecting the first user device 102 to the second user device 104 also make the second user device 104 discoverable by the first user device 102. In some embodiments, GPS location may be used to initiate transfer of the video stream from the first user device 102 to the second user device 104 when the first user device 102 is detected at certain coordinates or in a specific location. In embodiments, discovery of the second user device 104 by the first user device 102 initiates transfer of the video stream from the first user device 102 to the second user device 104.

In some embodiments, the trigger conditions 138 for initiating the transfer from the first user device 102 to the second user device 104 includes detecting that the user opened a second application different from the first application being used to conduct the video call. The trigger conditions 138 for initiating the transfer of the video stream to the second user device 104 include minimizing the first application being used to conduct the video call. In some embodiments, the transfer of the video stream to the second user device 104 is initiated when the first user device 102 returns to a home screen. In other embodiments, the transfer of the video stream to the second device 104 is initiated when the first user device 102 is locked, and the video stream remains transferred to the second user device 104 upon unlocking of the first user device 102.

As will be described in further detail below, initiating the transfer may include initially presenting a prompt to the user. The prompt may include confirmation that the user desires the video stream to be transferred to the second user device 104. In embodiments, the prompt includes an interface for a user to select whether permission for continuing the transfer of the video stream to the second user device is only for the present occurrence or includes permission for continuing the transfer on future occasions without prompting. The prompt may also include a user interface element that permits the user to identify the second user device 104 as a preferred device.

In some embodiments, the trigger conditions 138 for initiating the transfer of the video stream back to the first user device 102 from the second user device 104 include detecting user engagement with a user interface element for initiating the transfer of the video stream back to the first user device 102 from the second user device 104. The user interface element may be the same element as an indicator for indicating the first user device 102 is streaming video while causing display of the video stream on the second user device 104, e.g., status pill. In one or more embodiments, tapping the indicator causes display of the user interface element for initiating the transfer of the video stream between the first user device 102 and the second user device 104. In some embodiments, the user interface element for initiating the transfer is displayed on the first screen display 112 of the first user device 104 and may be displayed concurrently with the second application. In some embodiments, the user interface element for initiating the transfer back from the second user device 104 is selected by tapping the user interface element.

In some embodiments, the trigger conditions 138 also include trigger conditions for initiating transfer back to the first user device 102 from the second user device 104. The trigger conditions 138 may include detecting that the second user device 104 is no longer available. The second user device 104 may become unavailable when the second user device is unplugged and/or powered off. The second user device 104 may become unavailable when the method of communicating between the first user device 102 and the second user devices 102 is deactivated or disabled. For example, disabling Bluetooth on either or both of the first user device 102 or the second user device 104 prevents the second user device 104 from being discovered by the first user device 104. Similarly, going out of range of the second user device 104 or disconnecting the first user device 102 from the second user device 104 also makes the second user device 104 undiscoverable by the first user device 102. In some embodiments, the second user device 104 includes a user interface element that initiates the transfer of the video stream back to the first user device 102. In embodiments, loss of contact with the second user device 104 by the first user device 102 initiates transfer of the video stream back to the first user device 102 from the second user device 104.

In some embodiments, the trigger conditions 138 for initiating the transfer back to the first user device 102 from the second user device 104 includes detecting closing of the second application. In one or more embodiments, the trigger conditions 138 for initiating the transfer of the video stream back from the second user device 104 includes minimizing the second application and/or maximizing the first application.

In some embodiments, the first user device 102 includes the linked devices 140. The linked devices 140 are devices that have either been previously used by the first user device 102 or are devices that are available for use by the first user device 102. The linked devices 140 may include the second user device 104. In embodiments, detection of a linked device 140 by the operating system 142 of the first user device 102 initiates transfer of the video stream from the first user device 102 to the second user device 104. The linked devices 140 may include a preferred linked device and/or a hierarchy for the linked devices. In this manner, when more than one linked device is detected as being available at the same time, transfer of the video stream from the first user device 102 will be to the linked device with the higher preference. In embodiments, when a linked device with a higher preference than the device currently being used as the second user device 104 is detected, the video stream is transferred to the linked device with the higher preference.

In some embodiments the first user device 102 includes an operating system 142 for managing hardware, controlling functions, and providing a user interface for interacting with the device. The operating system 142 serves as the foundation for running applications and executing tasks on the first user device 102.

The operating system 142 may include iOS, iPadOS, Android, Windows, Chrome OS, or Fire OS. Developed by Apple, iOS is the operating system used exclusively on Apple's iPad tablets. iOS provides a user-friendly interface, seamless integration with other Apple devices and services, and access to the extensive App Store ecosystem. iOS offers a consistent user experience across Apple devices and is known for its stability, security, and optimized performance. iPadOS is a variant of iOS specifically designed for Apple's iPad tablets. iPadOS offers additional features and optimizations to take advantage of the larger tablet screen. iPadOS provides enhanced multitasking capabilities, Apple Pencil support, improved file management, and other tablet-specific functionalities.

Android is an open-source operating system developed by Google and used by various device manufacturers. Android offers a highly customizable user interface, a vast app ecosystem through Google Play Store, and integration with Google services. Android provides flexibility, allowing users to personalize their experience through widgets, custom launchers, and system-level settings. Windows is a widely used operating system developed by Microsoft. Devices running Windows, such as the Microsoft Surface lineup, offer a full desktop-like experience with support for traditional desktop applications. Windows devices allow users to run productivity software, access the Microsoft Store for apps, and provide compatibility with peripherals like keyboards and mice. Chrome OS, developed by Google, is a lightweight operating system that focuses on cloud-based computing, with apps primarily accessed through the Chrome browser and the Google Play Store. Chrome OS offers seamless integration with Google services, automatic updates, and a simplified user interface. Fire OS is a custom operating system developed by Amazon for their Kindle Fire devices. Fire OS is based on Android.

### Transferring Video Calls Between Devices

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

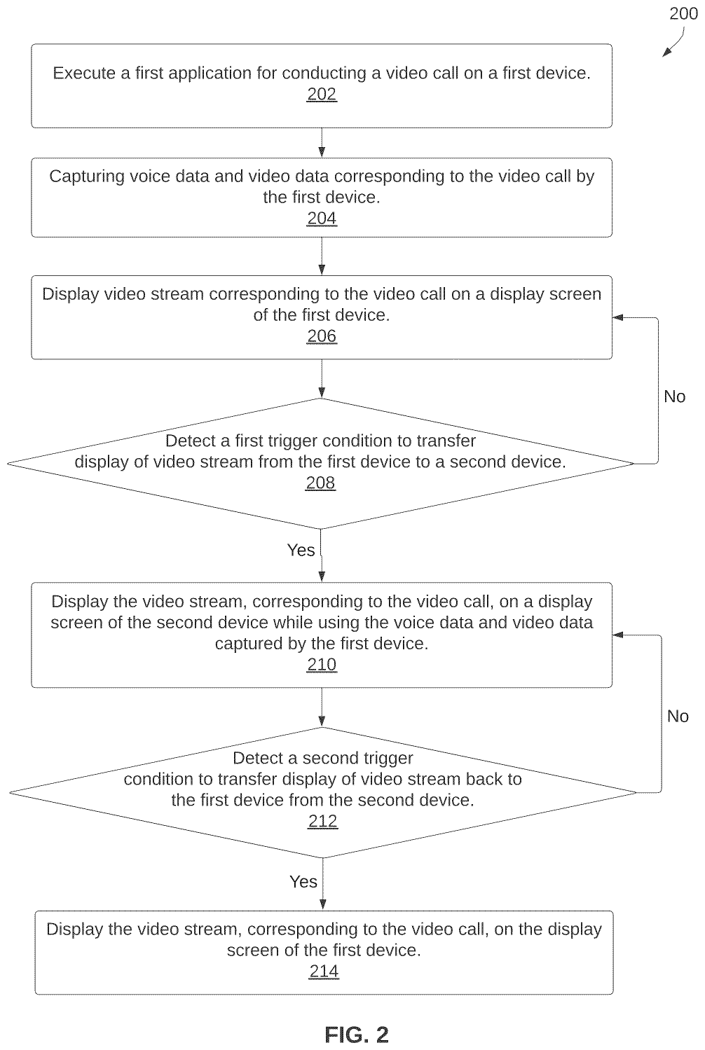

FIG. 2 is a flow diagram of an example process 200 for transferring a video stream of a video call being conducted using a first application of a first device to a second device allowing for use of a second application on the first user device.

In some embodiments a first application for conducting a video call is executed on a first device. (Operation 202). In one embodiment the first device is a tablet, e.g., Apple iPad, Samsung Galaxy Tab, and Amazon Fire. The first application includes at least one video application. Examples of video applications include Facetime, WhatsApp, Skype, Google Duo, Zoom, Microsoft Teams, and Facebook Messenger. The first application may be initiated by tapping on an icon for the first application. The icon for the first application may be displayed on a home screen of the operating system of the first device. In embodiments, a video call is initiated by selecting a person(s) to call from a list of people or by entering a phone number or other identification for the person(s) for which a video call is desired.

Some embodiments include capturing voice data and video data corresponding to the video call by the first device. (Operation 204). In embodiments, voice data is captured by a microphone of the first device and video data is captured by a camera of the first device. In embodiments, the camera and the microphone are positioned on the front side, i.e., the screen side, of the first device.

In embodiments the video stream corresponding to the video call is displayed on a display screen of the first device. (Operation 206). Displaying the video stream corresponding to the video call on the display screen of the first device initially includes displaying a video stream from a third device of the display screen of the first device. In embodiments, the third device is a smart phone, a tablet, a laptop or desktop, or smart TV enabled with built-in cameras and support video calling apps or services. Displaying the video stream to the display screen of the first device may optionally include displaying the video data captured by the camera of the first device. The display of the video data captured by the camera of the first device may performed concurrently with the display of the video stream from the third device. For example, the video data captured by the camera of the first device corresponding to the video call may be displayed as a picture within a picture. In embodiments, display of the video stream on the first device begins when the video call is established.

In some embodiments, the process 200 includes detecting a first trigger condition to transfer display of the video stream from the first device to a second device. (Operation 208). Until the first trigger condition is detected, either by the operating system of the first device or the first application, the video stream corresponding to the video call continues to be displayed on the display screen of the first device.

In one or more embodiments, the first trigger condition includes detecting user engagement with a user interface element on the first device. The user interface element may be displayed within the first application. In some embodiments the user interface element for initiating the transfer becomes selectable upon detection of a user action, e.g., swiping up on the display screen of the first device. In some embodiments detecting the first trigger condition includes detecting that the second device is available. Availability of the second device may be the result of plugging in the second device, powering up the second device, coming into range of second device, enabling communication protocol between the first and second devices, arriving at a predetermined GPS coordinate or location, and/or physically connecting the first device to the second device.

In some embodiments, the first trigger condition includes detecting the initial execution of a second application and/or detecting user input that switches to a window corresponding to the second application. In embodiments, switching to a window corresponding to the second application includes swiping up to open an app switcher or a recent apps view. Selection of the second application from within the app switcher or the recent apps view switches to a window corresponding to the second application. The second application is an application different from the first application and may include a productivity app, an entertainment app, a creative and multimedia app, an educational app, or a health and fitness app. In some embodiments, the first trigger condition includes detecting user engagement with the first device that minimizes the first application. The methods of minimizing the first application are dependent on the operating system of the first device. Minimizing the first application may include swiping up on the display screen of the first device. Minimizing the first application may include engaging a minimize button in the first application.

In some embodiments, detection of the first trigger condition elicits a prompt for the user to confirm the desired action, i.e., transferring the video stream from the first device to the second device. The prompt may also include indication that permission is being given for transferring the video stream for the present occasion only or for all future occasions that the first trigger condition is detected.

In some embodiments, the process 200 includes displaying the video stream corresponding to the video call on a display screen of the second device while using the voice data and video data captured by the first device. (Operation 210). In this manner, the first device operates as a webcam for the second device. By transferring the voice data and video data output from the first device to the second device, the display screen of the first device is freed up for the user to interact with the second application. In some embodiments, the operating system and/or hardware components of the first device are configured such that audio and video functions of the first device remain operable in the second application while displaying the video stream on the second device. The operating system may include features for canceling out audio output from the second application while displaying the video stream on the second device.

In some embodiments, concurrently with displaying the video stream on the second device, the first device displays application data corresponding to the second application. Displaying the application data may include displaying an icon for the second application on the first device. In some embodiments, the icon for the second application is located on the home screen of the operating system of the first device. In this manner, displaying application data includes returning to the home screen.

In embodiments, the second device is a smart TV capable of receiving the video stream directly from the first device and displaying the video stream on the display screen of the second device. In some embodiments, the second device is not capable of receiving the video stream directly from the first device, thereby necessitating the use of a streaming device. Streaming devices include Apple TV, Roku, Amazon Fire TV, and Google Chromecast.

In one or more embodiments the process 200 includes detecting a second trigger condition to transfer display of video stream back to the first device from the second device. (Operation 212). Until the second trigger condition is detected, either by the operating system of the first device or the first application, the video stream corresponding to the video call continues to be displayed on the display screen of the second device.

In one or more embodiments, the second trigger condition includes detecting user engagement with a user interface element on the first device. In some embodiments, the user interface element on the first device may be the same element as used to indicate to the user that the microphone and the camera of the first device are in use, particularly when the video stream is displayed on the second device. In some embodiments the user interface element for initiating the transfer becomes selectable upon detection of a user action, e.g., swiping up on the display screen of the first device.

In some embodiments detecting the second trigger condition includes detecting that the second device is no longer available. Unavailability of the second device may be the result of unplugging the second device, powering down the second device, going out of range of second device, disabling communication protocol between the first and second devices, leaving a predetermined GPS coordinate or location, and/or physically disconnecting the first device from the second device.

In some embodiments, the second trigger condition includes detecting closing of the second application. In some embodiments, the second trigger condition includes detecting user engagement with the first device that minimizes the second application. The methods of minimizing the second application are dependent on the operating system of the first device. Minimizing the second application may include swiping up on the display screen of the first device. Minimizing the second application may include engaging a minimize button in the second application.

In one or more embodiments, upon detection of the second trigger condition, the display of the video stream corresponding to the video call is displayed on the display screen of the first device. (Operation 214). In this manner, the video data corresponding to the video call being captured by the first device is displayed on the display screen of the first device and the voice data corresponding to the video call is output on a speaker of the first device.

In some embodiments, the video call is terminated by the user through engagement with a user interface element within the first application. The video call may also be terminated by the other person(s) on the video call.

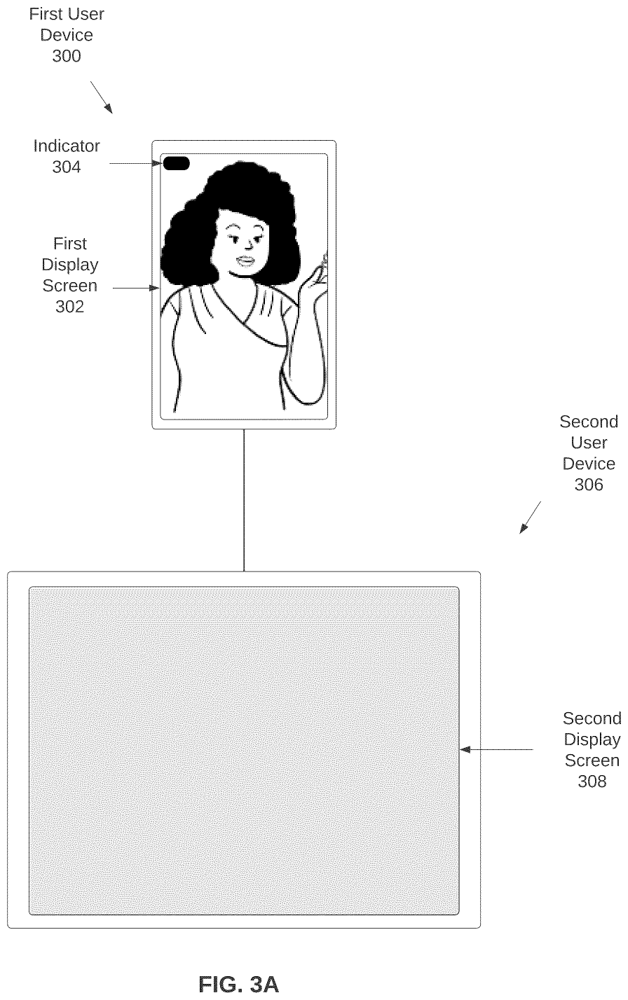

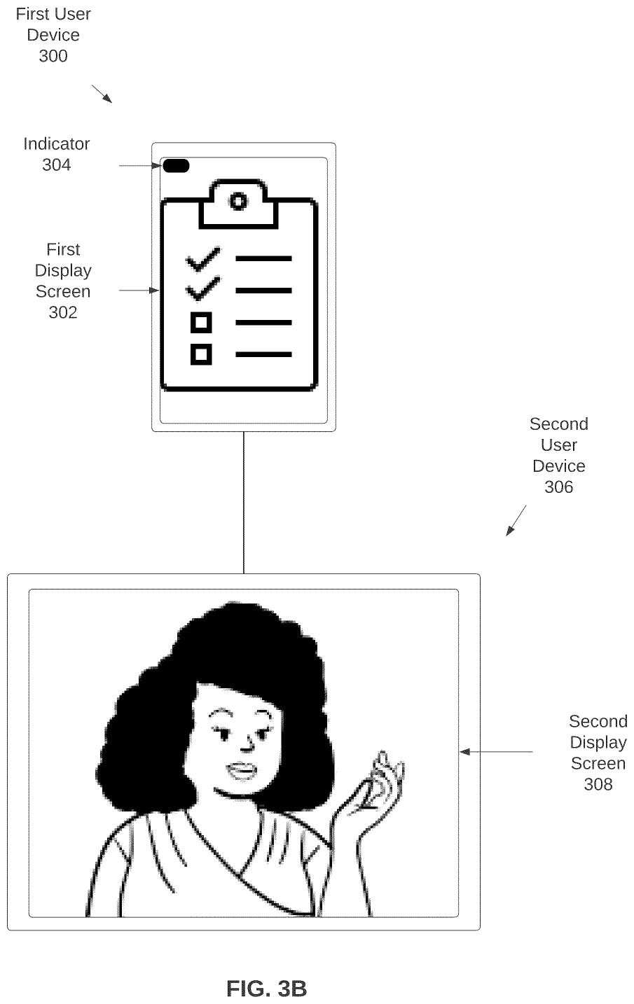

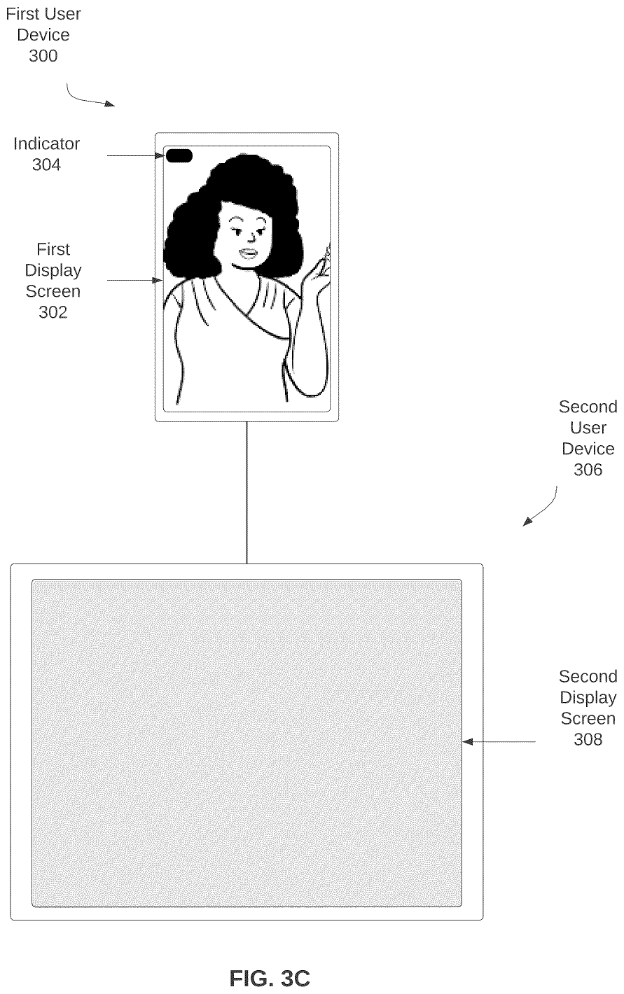

FIGS. 3A-3C illustrate the display screens of a first user device and a second user device during a video call prior to transferring display of the video stream of the video call to the second device, upon transferring the display of the video stream of the video to the second device, and upon transfer of the video stream of the video call back to the first device.

FIG. 3A illustrates a first user device 300 including a first display screen 302 and a second user device 306 including a second display screen 308. Prior to video stream of the video call being transferred to the second display screen 308 of the second user device, the video stream of the video call is displayed on the first display screen 302. As shown, the second display screen 308 is blank. However, the second user device 306 may display something other than the video stream from the first user device 300.

In one or more embodiments, the first user device 300 includes an indicator 304 for indicating that the camera and the microphone of the first user device 300 are in use. In some embodiments, the indicator 304 is referred to as a status pill. As shown, the status pill is black, indicating that the camera and the microphone are in use. The color or other attribute of the status pill may change depending on the status of the video stream. For example, when the video stream is paused, the status pill may turn gray, indicating that microphone and the camera are still engaged, but not active. The status pill may operate as a user interface element for causing display of one or more additional user interface elements.

FIG. 3B illustrates the video stream from the first user device 300 displayed on the second screen display 308 of the second device 306. The display of the video stream is transferred from the first user device 300 to the second user device 306 upon detection of a first trigger condition that initiates the transfer. The first user device 300 no longer displays the video stream. Instead, the first screen display 302 of the first user device 300 displays a second application. As shown, the second application includes a productivity app for generating and maintaining “to do” lists. The indicator 304 displayed on the first display screen 302 of the first user device 300 remains black as the camera and the microphone of the first user device 302 remain in use.

FIG. 3C illustrates the return of the video stream from the first user device 300 to the first screen display 302. The display of the video stream is transferred from the second user device 306 to the first user device 308 upon detection of a second trigger condition that initiates the transfer. The video stream is no longer displayed on the second display screen 308 of the second user device 306. Although shown as blank, the second display screen 308 may return to displaying what was displayed prior to the video stream being transferred to the second user device 306.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Example System Architecture

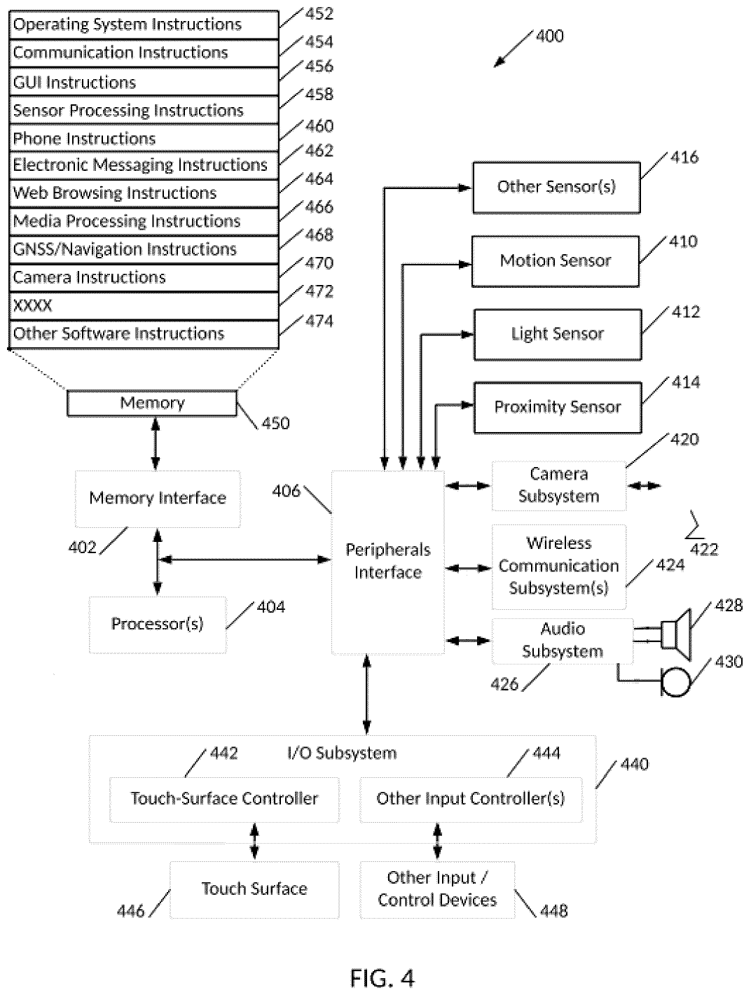

FIG. 4 is a block diagram of an example computing device 400 that can implement the features and processes of FIGS. 1-3C. The computing device 400 can include a memory interface 402, one or more data processors, image processors and/or central processing units 404, and a peripherals interface 406. The memory interface 402, the one or more processors 404 and/or the peripherals interface 406 can be separate components or can be integrated in one or more integrated circuits. The various components in the computing device 400 can be coupled by one or more communication buses or signal lines.

Sensors, devices, and subsystems can be coupled to the peripherals interface 406 to facilitate multiple functionalities. For example, a motion sensor 410, a light sensor 412, and a proximity sensor 414 can be coupled to the peripherals interface 406 to facilitate orientation, lighting, and proximity functions. Other sensors 416 can also be connected to the peripherals interface 406, such as a global navigation satellite system (GNSS) (e.g., GPS receiver), a temperature sensor, a biometric sensor, magnetometer, or other sensing device, to facilitate related functionalities.

A camera subsystem 420 and an optical sensor 422, e.g., a charged coupled device (CCD) or a complementary metal-oxide semiconductor (CMOS) optical sensor, can be utilized to facilitate camera functions, such as recording photographs and video clips. The camera subsystem 420 and the optical sensor 422 can be used to collect images of a user to be used during authentication of a user, e.g., by performing facial recognition analysis.

Communication functions can be facilitated through one or more wireless communication subsystems 424, which can include radio frequency receivers and transmitters and/or optical (e.g., infrared) receivers and transmitters. The specific design and implementation of the communication subsystem 424 can depend on the communication network(s) over which the computing device 400 is intended to operate. For example, the computing device 400 can include communication subsystems 424 designed to operate over a GSM network, a GPRS network, an EDGE network, a Wi-Fi or WiMax network, and a Bluetooth™ network. In particular, the wireless communication subsystems 424 can include hosting protocols such that the device 100 can be configured as a base station for other wireless devices.

An audio subsystem 426 can be coupled to a speaker 428 and a microphone 430 to facilitate voice-enabled functions, such as speaker recognition, voice replication, digital recording, and telephony functions. The audio subsystem 426 can be configured to facilitate processing voice commands, voiceprinting and voice authentication, for example.

The I/O subsystem 440 can include a touch-surface controller 442 and/or other input controller(s) 444. The touch-surface controller 442 can be coupled to a touch surface 446. The touch surface 446 and touch-surface controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 446.

The other input controller(s) 444 can be coupled to other input/control devices 448, such as one or more buttons, rocker switches, thumb-wheel, infrared port, USB port, and/or a pointer device such as a stylus. The one or more buttons (not shown) can include an up/down button for volume control of the speaker 428 and/or the microphone 430.

In one implementation, a pressing of the button for a first duration can disengage a lock of the touch surface 446; and a pressing of the button for a second duration that is longer than the first duration can turn power to the computing device 400 on or off. Pressing the button for a third duration can activate a voice control, or voice command, module that enables the user to speak commands into the microphone 430 to cause the device to execute the spoken command. The user can customize a functionality of one or more of the buttons. The touch surface 446 can, for example, also be used to implement virtual or soft buttons and/or a keyboard.

In some implementations, the computing device 400 can present recorded audio and/or video files, such as MP3, AAC, and MPEG files. In some implementations, the computing device 400 can include the functionality of an MP3 player, such as an iPod™.

The memory interface 402 can be coupled to memory 450. The memory 450 can include high-speed random-access memory and/or non-volatile memory, such as one or more magnetic disk storage devices, one or more optical storage devices, and/or flash memory (e.g., NAND, NOR). The memory 450 can store an operating system 452, such as Darwin, RTXC, LINUX, UNIX, OS X, WINDOWS, or an embedded operating system such as Vx Works.

The operating system 452 can include instructions for handling basic system services and for performing hardware dependent tasks. In some implementations, the operating system 452 can be a kernel (e.g., UNIX kernel). In some implementations, the operating system 452 can include instructions for performing the transfer of a video stream corresponding to a video call from a first device to a second device. For example, operating system 452 can implement the video streaming transfer features as described with reference to FIGS. 1-3C.

The memory 450 can also store communication instructions 454 to facilitate communicating with one or more additional devices, one or more computers and/or one or more servers. The memory 450 can include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GNSS/Navigation instructions 468 to facilitate GNSS and navigation-related processes and instructions; and/or camera instructions 470 to facilitate camera-related processes and functions.

The memory 450 can store software instructions 472 to facilitate other processes and functions, such as the video streaming transfer processes and functions as described with reference to FIGS. 1-3C.

The memory 450 can also store other software instructions 474, such as web video instructions to facilitate web video-related processes and functions; and/or web shopping instructions to facilitate web shopping-related processes and functions. In some implementations, the media processing instructions 466 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 450 can include additional instructions or fewer instructions. Furthermore, various functions of the computing device 400 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What is claimed is:

1. A non-transitory computer readable medium comprising instructions, which when executed by one or more hardware processors, cause performance of operations comprising:
executing, by a first device, a first application for conducting a video call, the first application (a) causing display of a video stream corresponding to the video call on a first display screen comprised in the first device and (b) utilizing voice data and video data captured by the first device for the video call;
detecting a first trigger condition for transferring display of the video stream from being displayed on the first device to being displayed on a second device;
responsive to detecting the first trigger condition:
the first device causing display of the video stream, corresponding to the video call, on the second device while the first application continues to utilize the voice data and the video data captured by the first device for the video call; and
concurrently with causing display of the video stream on the second device:
displaying, by the first device on the first display screen, application data corresponding to a second application that is different than the first application.

2. The non-transitory computer readable medium of claim 1, wherein the operations further comprise:
concurrently with displaying the video stream corresponding to the video call on the first display screen, playing an audio stream corresponding to the video call on a first audio component corresponding to the first device,
wherein further responsive to detecting the first trigger condition, the first device causing playing of the audio stream on a second audio component corresponding to the second device.

3. The non-transitory computer readable medium of claim 1, wherein the operations further comprise:
detecting a second trigger condition for transferring display of the video stream back to being displayed on the first device from being displayed on the second device; and
responsive to detecting the second trigger condition:
the first device causing display of the video stream, corresponding to the video call, on the first display screen of the first device while the first application continues to utilize the voice data and the video data captured by the first device for the video call.

4. The non-transitory computer readable medium of claim 1, wherein detecting the first trigger condition includes detecting user engagement with a user interface element on the first device for initiating transfer of the video stream to the second device.

5. The non-transitory computer readable medium of claim 1, wherein detecting the first trigger condition includes detecting that the second device is available.

6. The non-transitory computer readable medium of claim 1, wherein detecting the first trigger condition includes detecting opening of the second application.

7. The non-transitory computer readable medium of claim 1, wherein detecting the first trigger condition includes detecting user engagement with the first device to minimize the first application.

8. The non-transitory computer readable medium of claim 3, wherein detecting the second trigger condition includes detecting user engagement with a user interface element on the first device terminating transfer of the video stream to the second device.

9. The non-transitory computer readable medium of claim 3, wherein detecting the second trigger condition includes detecting that the second device is unavailable.

10. The non-transitory computer readable medium of claim 3, wherein detecting the second trigger condition includes detecting closing of the second application.

11. The non-transitory computer readable medium of claim 1, wherein an operating system of the first device causes display of the video stream on the second device.

12. The non-transitory computer readable medium of claim 1, wherein an operating system of the first application causes display of the video stream on the second device.

13. The non-transitory computer readable medium of claim 1, wherein the second device is a television.

14. The non-transitory computer readable medium of claim 1, wherein causing display of the video stream on the second device includes transmitting the video stream to a streaming device.

15. The non-transitory computer readable medium of claim 1, wherein voice data and video data for the video call are captured by a microphone of the first device and a camera of the first device.

16. A method comprising:
executing, by a first device, a first application for conducting a video call, the first application (a) causing display of a video stream corresponding to the video call on a first display screen comprised in the first device and (b) utilizing voice data and video data captured by the first device for the video call;
detecting a first trigger condition for transferring display of the video stream from being displayed on the first device to being displayed on a second device;
responsive to detecting the first trigger condition:
the first device causing display of the video stream, corresponding to the video call, on the second device while the first application continues to utilize the voice data and the video data captured by the first device for the video call; and
concurrently with causing display of the video stream on the second device:
displaying, by the first device on the first display screen, application data corresponding to a second application that is different than the first application.

17. The method of claim 16, further comprising:
concurrently with displaying the video stream corresponding to the video call on the first display screen, playing an audio stream corresponding to the video call on a first audio component corresponding to the first device,
wherein further responsive to detecting the first trigger condition, the first device causing playing of the audio stream on a second audio component corresponding to the second device.

18. The method of claim 16, further comprising:
detecting a second trigger condition for transferring display of the video stream back to being displayed on the first device from being displayed on the second device; and
responsive to detecting the second trigger condition:
the first device causing display of the video stream, corresponding to the video call, on the first display screen of the first device while the first application continues to utilize the voice data and the video data captured by the first device for the video call.

19. A system comprising:
one or more processors; and
a non-transitory computer-readable medium including one or more sequences of instructions that, when executed by one or more processors, cause the processors to perform operations comprising:
executing, by a first device, a first application for conducting a video call, the first application (a) causing display of a video stream corresponding to the video call on a first display screen comprised in the first device and (b) utilizing voice data and video data captured by the first device for the video call;
detecting a first trigger condition for transferring display of the video stream from being displayed on the first device to being displayed on a second device;
responsive to detecting the first trigger condition:
the first device causing display of the video stream, corresponding to the video call, on the second device while the first application continues to utilize the voice data and the video data captured by the first device for the video call; and
concurrently with causing display of the video stream on the second device:
displaying, by the first device on the first display screen, application data corresponding to a second application that is different than the first application.

20. The system of claim 19, wherein the operations further comprise:
concurrently with displaying the video stream corresponding to the video call on the first display screen, playing an audio stream corresponding to the video call on a first audio component corresponding to the first device,
wherein further responsive to detecting the first trigger condition, the first device causing playing of the audio stream on a second audio component corresponding to the second device.

21. The system of claim 19, wherein the operations further comprise:
detecting a second trigger condition for transferring display of the video stream back to being displayed on the first device from being displayed on the second device; and
responsive to detecting the second trigger condition:
the first device causing display of the video stream, corresponding to the video call, on the first display screen of the first device while the first application continues to utilize the voice data and the video data captured by the first device for the video call.
